(19) United States
(12) Patent Application Publication
(10) Pub. No.: US 2025/0123746 A1
(43) Pub. Date: Apr. 17, 2025

(54) MEMORY SYSTEM, METHOD, AND MEMORY DEVICE WITH OFFLOADING

(71) Applicant: SAMSUNG ELECTRONICS CO., LTD., SUWON-SI (KR)

(72) Inventor: SEONGWOOK PARK, Suwon-si (KR)

(21) Appl. No.: 18/814,996

(22) Filed: Aug. 26, 2024

(30) Foreign Application Priority Data
Oct. 16, 2023 (KR) 10-2023-0137680

(51) Int. Cl. G06F 3/06

(52) U.S. Cl. CPC G06F 3/0608; G06F 3/0647; G06F 3/0673

(57) ABSTRACT

A memory system includes an external memory device and a first memory processing unit of a main memory device. The external memory device and a host may be disposed on different boards, and the external memory device may transfer compressed data to the host in response to a swap-in request from the host. The first memory processing unit and the host may be disposed on the same board. The first memory processing unit may load the compressed data, decompress the compressed data to obtain decompressed data, and store the decompressed data in a main memory of the main memory device.

### CROSS-REFERENCE TO RELATED APPLICATION

This application is based on and claims priority under 35 U.S.C. § 119 to Korean Patent Application No. 10-2023-0137680 filed on Oct. 16, 2023, in the Korean Intellectual Property Office, the contents of which are incorporated by reference herein in their entirety.

### BACKGROUND

### Field of the Invention

The following disclosure relates to a memory system with offloading.

### Description of the Related Art

Memory systems are vital in determining the overall performance and efficiency of computing and electronic devices. Recently, there is an ever-increasing demand for faster data access and processing capabilities. As a result, memory systems employ architectures that can manage memory related tasks for improved computational efficiency. In some cases, such architectures may include transfer of certain memory functions to different modules or devices that can reduce the load on the main memory system.

However, existing memory systems encounter limitations in efficiently managing and processing data, particularly in scenarios where there is a high demand for simultaneous data access and execution of tasks. Such systems for handling memory-related functions may lead to bottlenecks and reduced system performance. Therefore, there is a need in the art for systems and methods that can enhance memory systems to meet the requirements of modern computing applications.

### SUMMARY

The present disclosure describes a memory system including a memory device that incorporates an offloading mechanism for managing memory related tasks. Embodiments of the disclosure include performing an offloading operation to a peripheral memory device. In some cases, the peripheral memory device may be connected to a host. According to an embodiment, the peripheral memory device performs the offloading operation based on a zSwap process, wherein size of a data to be swapped or offloaded to a different memory device is reduced.

According to an aspect, a memory system is provided that includes an external memory device configured to transfer compressed data to a host in response to a swap-in request by the host, and a first memory processing unit of a main memory device configured to load the compressed data, decompress the compressed data to obtain decompressed data, and store the decompressed data in a main memory of the main memory device.

A buffer unit including the first memory processing unit may be configured to store the compressed data received from the external memory device in the main memory, perform a decompression operation on the compressed data to obtain the decompressed data, transfer the decompressed data to the host, and remove the compressed data from the main memory after the compressed data is decompressed.

The external memory device may include a second memory processing unit configured to receive data from the main memory, and compress the received data to obtain the compressed data, and a second memory configured to store the compressed data.

The external memory device may be further configured to store non-compressed data classified as cold data in a second memory, compress the non-compressed data to obtain the compressed data, store the compressed data in the second memory, and remove the non-compressed data from the second memory after the compressed data is stored in the second memory.

The host may be configured to classify data unused within a period as cold data, and the external memory device may be further configured to receive the data classified as cold data from the main memory and store the received data in a second memory.

The host may be configured to load the decompressed data from the main memory and use the compressed data.

The first memory processing unit may be implemented in a host processor of the host or on a layer adjacent to the host processor.

A main memory device having the first memory processing unit and the main memory may be disposed on the same board as the host, and the external memory device and the host may be disposed on different boards.

The host may include a host processor having a cache corresponding to the main memory and the first memory processing unit.

The memory system may further include an additional external memory device configured to perform a compression, the additional external memory device and the host being disposed on different boards, wherein the host may be configured to transfer data to the external memory device when a swap memory pool of the external memory device is available, and transfer data to the additional external memory device when the swap memory pool of the external memory device is unavailable.

According to an aspect, there is provided a method of operating a memory system including transferring, by an external memory device, compressed data to a host in response to a swap-in request from the host, loading, by a first memory processing unit, the compressed data in response to the swap-in request, decompressing, by the first memory processing unit, the compressed data to obtain decompressed data, and storing, by the first memory processing unit, the decompressed data in a first memory.

According to an aspect, there is provided a memory device including a memory area disposed on the same board as a host, wherein the memory area is configured to store data, and a memory processing unit disposed on the same board as the host, wherein the memory processing unit is configured to decompress the compressed data to obtain decompressed data, store the decompressed data in the memory area, and transfer data to another memory device.

According to an aspect, there is provided a method of operating a memory system including transferring data to an external memory device in response to a swap-out request from a host, compressing, by the external memory device, the data to obtain compressed data, transferring, by the external memory device, the compressed data to a main memory device in response to a swap-in request from the host, and decompressing, by the main memory device, the compressed data to obtain decompressed data.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings:

FIGS. 1A and 1B illustrate a memory system according to an embodiment;

FIG. 2 illustrates swapping pages for an application in a memory system according to an embodiment;

FIG. 3 is a flowchart illustrating a swap-in method according to an embodiment;

FIGS. 4 and 5 are diagrams illustrating a zSwap process according to an embodiment;

FIG. 6 illustrates a memory system with offloading using a dual in-line memory module (DIMM) memory and a compute express link (CXL) memory according to an embodiment; and

FIG. 7 illustrates a memory system with host-based split offloading according to an embodiment.

FIG. 8 is a flowchart illustrating a swap-out method performed by a memory device according to an embodiment.

### DETAILED DESCRIPTION

The present disclosure describes a memory system including a memory device that incorporates an offloading mechanism for managing memory related tasks. Embodiments of the disclosure include performing an offloading operation to a peripheral memory device. In some cases, the peripheral memory device may be connected to a host. According to an embodiment, the peripheral memory device performs the offloading operation based on a zSwap process, wherein a size of a data to be swapped or offloaded to a different memory device is reduced.

Swap is a memory management technique that reduces a memory shortage by transferring a portion of memory allocated to an application program to an auxiliary storage device (e.g., a solid-state drive (SSD) or a hard disk drive (HDD)). In some cases, the SSD or HDD may include a relatively large capacity and a main memory area to be allocated to the application program is insufficient.

In some cases, when a main memory area in a system is insufficient, an operating system may secure a main memory space by moving data in a memory area already allocated to an application program (e.g., pages in a Linux system that uses a virtual memory) to a swap area of a non-volatile memory used as an auxiliary storage device. However, the cost of moving data (e.g., pages) to an auxiliary storage device is considerable. In some cases, data needs to be transmitted through a relatively slow system bus compared to the main memory, and the stored data needs to be retrieved to the main memory, if necessary. As a result, the performance of the application program may be degraded.

Embodiments of the present disclosure include a memory system that performs an offloading process based on a zSwap operation. In some cases, the peripheral memory device is connected to a host and is connected to the memory system performing the zSwap operation. According to an embodiment, the offloading process may include data compression when moving to a memory pool and decompression of a required data based on a host request. That is, the size of the data to be transferred is reduced.

According to an embodiment, the data compression process may be performed on an encoded data. In some cases, the encoding (e.g., an encoding component) may be disposed on a memory layer closer to a peripheral memory device than the host. Additionally, the data decompression process may be performed by decompressing the compressed data. In some cases, the decompression may be performed after a decoding process, wherein the decoding (e.g., decoding component) is disposed on a memory layer closer to a host than the peripheral memory device.

Embodiments of the present disclosure include a data processing method that compresses data and stores the compressed data in a main memory (i.e., rather than moving the data to an auxiliary storage device). Accordingly, by performing the zSwap operation wherein a compression of data is performed, embodiments enable minimization of the memory space usage. Additionally, bandwidth between the host and peripheral devices may be reduced. By effectively improving the utilization of interface between the host and peripheral devices with a high-power consumption, the overall system power efficiency of the system may be maximized.

Embodiments of the present disclosure include a memory system comprising an external memory device configured to transfer compressed data to a host in response to a swap-in request from the host. In some cases, the memory system may include a first memory processing unit of a main memory device configured to load the compressed data, decompress the compressed data to obtain decompressed data, and store the decompressed data in a main memory of the main memory device.

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, a memory system and an offloading process of the memory system of the embodiments of the present disclosure will be described in detail with reference to the accompanying drawings. When describing the embodiments with reference to the accompanying drawings, like reference numerals refer to like elements and a repeated description related thereto will be omitted.

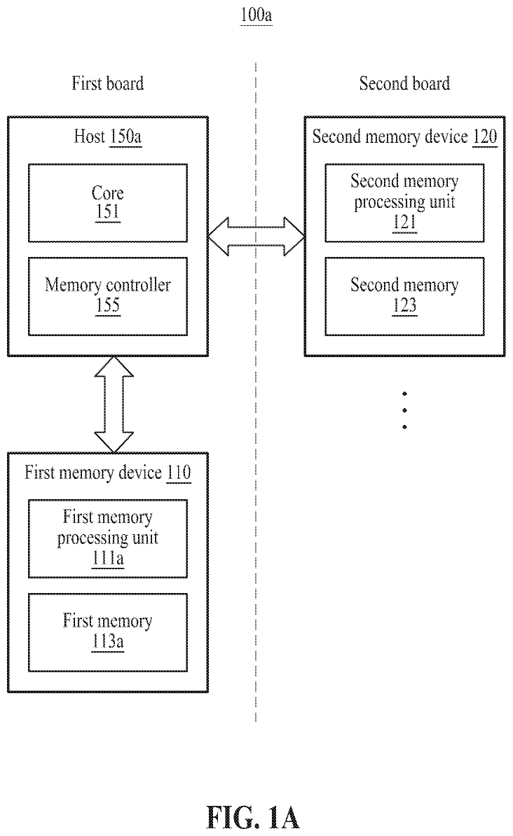

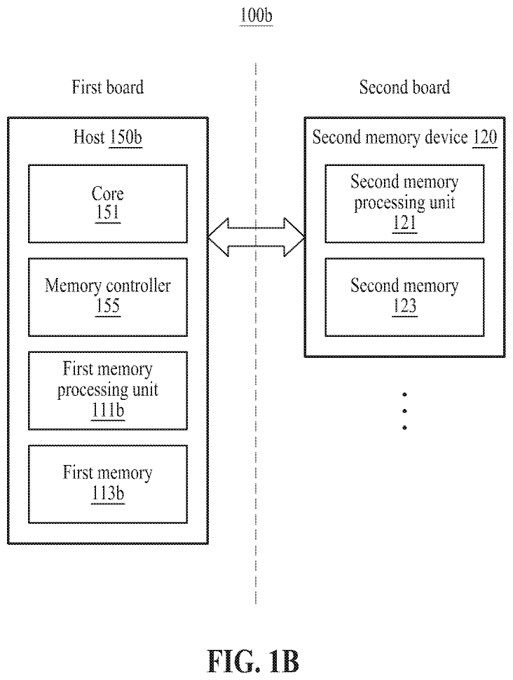

FIGS. 1A and 1B illustrate a memory system according to an embodiment.

According to an embodiment, each of memory systems 100a, 100b may provide offloading of an operation. For example, the memory systems 100a, 100b may provide offloading of an operation between a host device and a peripheral device. Offloading may provide for a peripheral device (e.g., a peripheral memory device 110, 120 or a first memory device 110 and a second memory device 120) to perform a portion of operations (i.e., instead of a host 150a in the memory systems 100a, 100b). For example, the memory systems 100a, 100b may offload (e.g., distribute) an operation from the host 150a (e.g., a host central processing unit (CPU)) to the peripheral memory devices 110, 120.

Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit to perform various functions described herein.

In some cases, memory includes a basic input/output system (BIOS) that controls basic hardware or software operations, such as an interaction with peripheral components or devices. In some cases, memory includes a memory controller that operates memory cells of a memory unit. For example, the memory controller may include a row decoder, column decoder, or both. In some cases, memory cells within memory unit store information in the form of a logical state. In some examples, the memory devices 110, 120 may include a memory processing unit (e.g., an accelerator).

According to an embodiment, the first memory device 110 may be on a same board as the host 150a. For example, as shown in FIG. 1, the first memory device 110 and the host 150a may each be disposed on a first board. In some cases, the first memory device may be an internal or main memory device. In some examples, the first memory device 110 may be a random access memory (RAM) that provides fast and temporary storage for actively running programs and data.

According to an embodiment, the second memory device 120 may be on a different board than the host 150a. For example, as shown in FIG. 1, the host 150a may be disposed on a first board and the second memory device 120 may be disposed on a second board different from the first board. In some cases, the second memory device may be an external memory device or an auxiliary storage device which refer to additional storage devices that extend a capacity of a device. In some examples, the second memory device 120 may be hard disk drives (HDDs) for large-scale data storage, solid state drives (SSDs) for faster access and durability.

In a memory device, the term “board” refers to a printed circuit board (PCB) housing memory chips and associated components. The PCB includes connectors for attachment to a computer's motherboard, facilitating electrical connections. In some cases, the board encompasses memory chips, a controller managing data flow, and circuits ensuring efficient communication. The memory board, essential for data storage and retrieval, is integral to memory modules like DIMM or SIMM in computer systems. Referring to FIGS. 1A-1B, the dashed line separates the first board including the host and first memory device (e.g., internal memory device) from the second memory device (e.g., external memory device).

In some cases, the memory processing unit may refer to a processing near memory (PNM) unit or a processing in memory (PIM) unit. Herein, an example of the memory processing unit being a PNM unit is mainly described, but embodiments are not limited thereto. Unless otherwise described, the description may also apply to a PIM unit. A PIM unit integrates processing capabilities directly within a memory module and provides for concurrent processing and data storage, reducing data transfer bottlenecks and enhancing overall system efficiency. By executing computations within the memory, PIM units significantly accelerate tasks, making them ideal for applications requiring high-speed data processing, such as artificial intelligence and data analytics, thereby revolutionizing conventional computing paradigms.

The memory devices (e.g., each of first memory device 110 and second memory device 120) may process an offloading operation using the PNM unit. Each of the memory systems 100a, 100b that support offloading may have a hardware structure that minimizes communication involved in offloading. Since the operation to be performed by the host 150a is partially distributed to a peripheral device, the host 150a may process a high number of tasks more efficiently. Thus, the performance of the host 150a may be improved.

According to an embodiment, the memory systems 100a, 100b may include the host (e.g., host 150a and 150b in FIGS. 1A-1B), a first memory processing unit (e.g., 111a and 111b), and a second memory processing unit 121.

The host 150a is a main management entity of a computer system (e.g., an electronic device) and may be implemented as a host processor or as a server. The host processor may include, for example, a host CPU. For example, the host processor may include a processor core 151 and a memory controller 155.

A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. The processor is configured to operate a memory array using a memory controller. In other cases, a memory controller is integrated into processor. In some cases, processor is configured to execute computer-readable instructions stored in memory to perform various functions. In some aspects, processor includes special purpose components for modem processing, baseband processing, digital signal processing, or transmission processing.

A server provides one or more functions to users linked by way of one or more of various networks. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages).

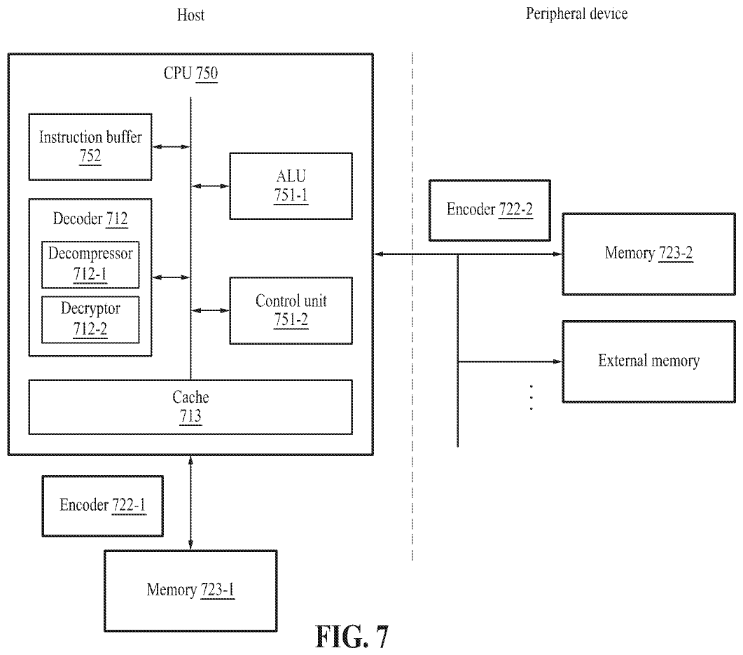

As described below, an offloading decoder (e.g., a decoder 712 as described with reference to FIG. 7) may also be implemented to be integrated into the processor core 151. The memory controller 155 may control the peripheral memory devices 110, 120. In some examples, the memory controller 155 may transmit an instruction to the memory devices 110, 120. Further, the host processor may process data received from the memory devices 110, 120 using the processor core 151. As described with reference to FIG. 7, the processor core 151 may include an arithmetic and logical unit (ALU) and a control unit.

The memory processing unit (each of 111a, 111b, 121 in FIGS. 1A-1B) may access an adjacent memory (e.g., a memory block) and perform an operation (e.g., PNM operation) using the values written to the memory block. The memory processing unit 111a, 111b, 121 may also be referred to as an accelerator. The memory processing unit 111a, 111b, 121 may be a set (e.g., a logic circuit) of logic elements manufactured and/or implemented to include logic for a designated operation. The first memory processing unit 111a may be disposed with a layer (e.g., a memory layer) closer to the host 150a than the second memory processing unit 121. For example, in the aspect of the memory layer, the memory system 100a, 100b may include devices which are connected in the following order: the host 150a, the first memory processing unit 111a, and the second memory processing unit 121 (i.e., indicating the connection order of the devices).

According to an example, the first memory processing unit 111a may be positioned on the same board (e.g., a first board) as the host 150a. The second memory processing unit 121 may be positioned on a board (e.g., a second board) different from the board (e.g., the first board) on which the host 150a is positioned. A peripheral device including the memory processing unit 111a, 111b, 121 may also be referred to as a PNM device. The memory devices 110, 120 having a PNM unit may also be referred to as a PNM memory device. The PNM memory device may include, for example, an acceleration dual in-line memory module (AXDIMM), a compute eXpress link-AXDIMM (CXL-AXDIMM), and a CXL-disaggregated memory pool (MDP).

The AXDIMM is a memory module that incorporates acceleration capabilities directly alongside traditional memory functions. The dual-purpose design enables efficient parallel processing, enhancing overall system performance. AXDIMMs excel in data-intensive tasks, offering accelerated computations within the memory module. Such an integration optimizes resource utilization and significantly reduces latency, making AXDIMMs a key advancement in memory technology.

The CXL-AXDIMM represents a paradigm shift in memory architecture by combining the capabilities of Compute eXpress Link (CXL) technology with AXDIMM. The integration enables high-speed communication between processors and memory, facilitating seamless data transfer and accelerated processing. CXL-AXDIMMs are used in workloads demanding rapid access to large datasets. The incorporation of CXL enhances overall system bandwidth, making it a versatile solution for diverse computing applications.

The CXL-Disaggregated Memory Pool (DMP) is based on separating memory resources from processing units. Such a disaggregation provides for flexible allocation of memory across multiple processors, optimizing resource utilization and scalability. CXL-DMP leverages Compute eXpress Link technology to facilitate efficient communication between disaggregated components. The method provides enhanced adaptability for evolving workloads, resulting in advancement of memory architecture.

For reference, the memory devices 110, 120 are mainly described herein as an example of a peripheral device, but embodiments are not limited thereto. Unless otherwise described, the structure and/or operation described below may also apply to various types of peripheral devices including a memory and a PNM unit. The PNM unit may also be implemented to be integrated into a CXL switch, the memory controller (MC) 155, and an interface unit.

According to an embodiment, the memory devices 110, 120 may include the memory processing unit (e.g., first memory processing unit 111a, second memory processing unit 121), and a memory (e.g., first memory 113a and second memory 123). The peripheral memory devices 110, 120 may be, for example, a memory device disposed and connected adjacent to the host 150a. For example, referring to FIG. 1A, the first memory device 110 including the first memory processing unit 111a and the first memory 113a and the second memory device 120 including the second memory processing unit 121 and the second memory 123 are illustrated. A memory device disposed on a board (e.g., the second memory device disposed on the second board) different from the board (e.g., the first board) on which the host 150a (or the host device) is mounted may be referred to as an external memory device. Accordingly, in FIGS. 1A and 1B, the second memory device 120 may be an external memory device. For example, the dashed line in FIGS. 1A and 1B may separate the first board and the second board.

Each of the memory devices 110, 120 may include a memory area to store data. The memory area may be an area (e.g., a physical area) from which data can be read and/or to which data can be written in a memory chip of the physical memory device (e.g., peripheral memory devices 110, 120). The memory area may be disposed in a memory die (or a core die) of the memory devices 110, 120. The memory devices 110, 120 may cooperate with the host processor to process data in the memory area. For example, the memory devices 110, 120 may process data based on an instruction received from the host processor. The memory devices 110, 120 may control the memory area in response to the instruction from the host processor.

In some cases, the memory devices 110, 120 may be separate from the host processor. For reference, the host processor may direct each operation of the plurality of operations and delegate an operation requiring acceleration (e.g., a swap operation as a processing-near-memory (PNM) operation) to the memory device 110, 120. Among the memory devices 110 and 120 described above, the operation offloaded to the first memory device 110 may be different from the operation offloaded to the second memory device 120. The operation and data offloaded to each memory device 110, 120 are described below in relation to swap as an example of an offloading operation.

A memory may store data. The memory may include a plurality of memory blocks that form a memory area. The plurality of memory blocks may be generated using a portion or all of the memory chips of the memory device 110, 120. Each memory block may correspond to a memory bank, and the plurality of memory blocks may be grouped by memory rank and/or memory channel. For example, a memory rank may be a set of memory chips (e.g., dynamic random-access memory (DRAM) chips) connected to the same chip selected and thus accessible simultaneously. A memory channel may be a set of memory chips accessible via the same channel (e.g., memory channel).

According to an embodiment, the host 150a of each of the memory systems 100a, 100b may divide and offload operations to the first memory processing unit 111a and the second memory processing unit 121. For example, the offloaded operations may be swap operations. A memory swap operation may be an operation of moving data from a memory area of a main memory (e.g., a main memory area) to a memory area of an external memory (e.g., an external memory area) when the main memory area is insufficient.

Swap memory, in a computing context, pertains to a storage technique where data is temporarily transferred between RAM and a storage device (e.g., an external storage device) to manage system resources efficiently. In some cases, the method involves dynamic allocation and retrieval of data between these storage elements to optimize performance. Accordingly, the swap method is employed to enhance system performance by managing data efficiently, particularly in scenarios of limited memory capacity. By swapping data between storage locations, the memory swap operation contributes to improved processing speed and overall system responsiveness.

Referring to FIG. 1A, the first memory device 110 may be the main memory device, the first memory 113a may be the main memory, the second memory device 120 may be the external memory device, and the second memory 123 may be the external memory. For example, an operating system executed by the host 150a may move data from a memory area already allocated to an application program to a swap area of the second memory 123 (e.g., the external memory) when the memory area of the first memory 113a (e.g., the main memory) in the memory system 100a, 100b is insufficient. The external memory device is an auxiliary memory device and may be, for example, a non-volatile memory device. For example, the data assigned to the application program may be a page in a Linux system that uses virtual memory. The memory space of the first memory 113a (e.g., the main memory) may be secured through the memory swap operation as described.

The memory swap operation may include an operation of compressing data to be moved to the swap area and an operation of decompressing required data (e.g., data to be used by the host 150a). The operation of compressing and storing swap data in the swap area (e.g., a swap memory pool) and then decompressing the compressed data and using the decompressed data requested by the host 150a may be referred to as a zSwap operation. In the zSwap operation, the size of the data swapped to the swap area is reduced, so the memory space usage may be minimized. In addition, since the compressed data is moved from the first memory 113a (e.g., the main memory) to the second memory 123 (e.g., the external memory), the usage of memory transfer bandwidth may decrease. Therefore, the zSwap operation is more efficient (e.g., compared to a memory swap operation) in terms of performance.

According to an embodiment, each of the memory systems 100a, 100b may distribute the operation involved in the memory swap (e.g., the zSwap operation) as described and/or operations (e.g., the compression operation and the decompression operation) to the first memory processing unit 111a and the second memory processing unit 121. As used herein, a swap-in may be an operation of decompressing compressed data stored in the second memory 123 and storing the decompressed data in the first memory 113a. As used herein, a swap-out may be an operation of compressing non-compressed data stored in the first memory 113a and storing the compressed data in the second memory 123.

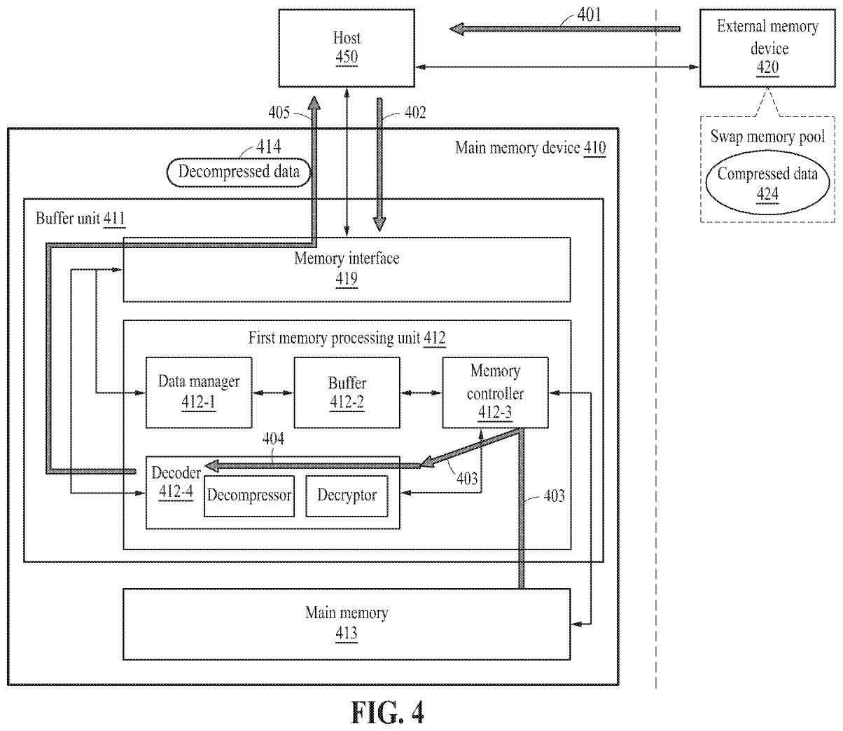

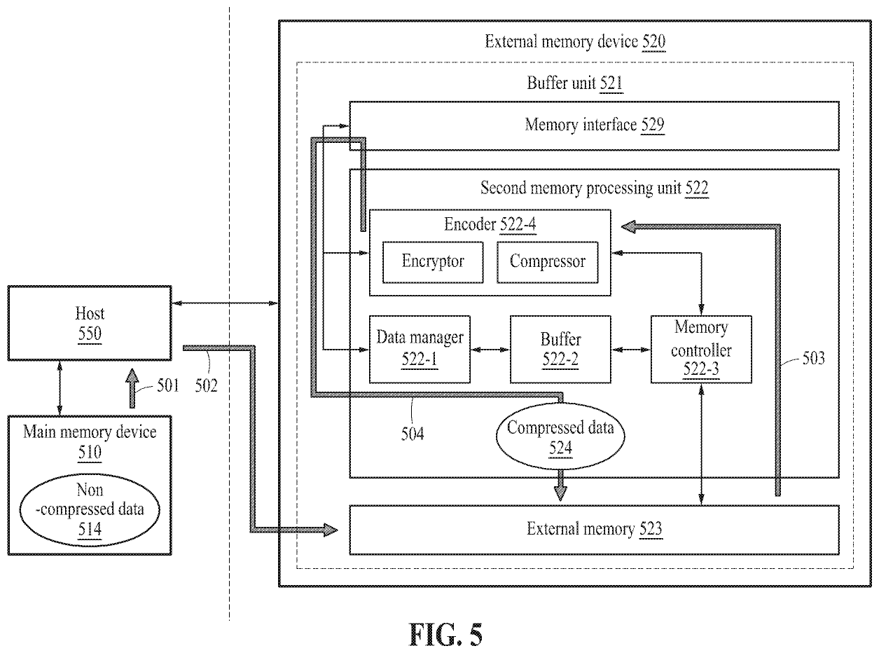

According to an example, in case of the zSwap operation, the first memory processing unit 111a may be in charge of the swap-in operation (e.g., the decompression operation), and the second memory processing unit 121 may be in charge of the swap-out operation (e.g., the compression operation). The first memory processing unit 111a may include a set (e.g., a logic circuit) of logic elements that implement decoding logic and/or decompressing logic. Similarly, the second memory processing unit 121 may include a set (e.g., a logic circuit) of logic elements that implement encoding logic and/or compressing logic. The structure of the first memory processing unit 111a for the decompression operation is described with reference to FIG. 4. The structure of the second memory processing unit 121 for the compression operation is described with reference to FIG. 5.

The first memory processing unit 111a may load compressed data corresponding to a swap-in received from the host 150a in response to the swap-in request by the host 150a. The first memory processing unit 111a may obtain decompressed data by decompressing the compressed data. The first memory processing unit 111a may store the decompressed data in the first memory 113a. That is, the first memory 113a may store the decompressed data. Thereafter, the host 150a may access the first memory 113a and use the decompressed data. As described, the first memory processing unit 111a and the host 150a may be disposed on the same board (e.g., first board).

The second memory device 120 (e.g., the external memory device) may transfer the compressed data corresponding to the swap-in to the host 150a in response to a request by the host 150a. The second memory device 120 and the host 150a may be disposed on different boards (e.g., second board and first board, respectively), as described. The second memory device 120 (e.g., the external memory device) may include the second memory processing unit 121 and the second memory 123.

The second memory processing unit 121 may receive data corresponding to a swap-out from the first memory 113a via the host 150a in response to the swap-out request by the host 150a. The second memory processing unit 121 may generate compressed data by compressing the received data. That is, the second memory 123 may store the compressed data.

According to an embodiment, accelerated logic circuits for offloading an operation may be distributed and disposed in the memory system 100a, 100b. An accelerated logic circuit enhances the processing speed of logical operations within electronic circuits. By employing specialized hardware accelerators, these circuits expedite computations in tasks such as data processing, artificial intelligence, and complex calculations. Accelerated logic circuits optimize performance by offloading specific functions, leading to faster execution and improved efficiency in electronic systems. The circuits are used in meeting the demands of high-performance computing applications and contribute to advancements in computational speed and overall system responsiveness.

As described, the buffer unit (e.g., the buffer chip) to which a swap-out operation is offloaded may be different from the buffer unit to which a swap-in operation is offloaded. Accordingly, the resource consumption of the host 150a for swap-in and swap-out may be reduced. Each of the memory systems 100a, 100b may minimize the additional processing required to be performed by the host 150a in a zSwap operation, thereby improving the utilization of the host 150a and the system performance.

In addition, the data bandwidth between the host 150a and the memory devices used for the zSwap operation may also be reduced. For example, during a swap-in operation, the host 150a may receive compressed data from the second memory device 120 and transfer the compressed data to the first memory device 110. Data transmission between different boards (e.g., from second board to first board during a swap-in operation) may be performed with compressed data. Thus, in the swap-in operation, the data bandwidth between the host 150a and the second memory device 120 (e.g., the external memory device) may be reduced. As the data bandwidth is reduced, power consumption may be reduced, and the access latency between the host 150a and the peripheral device may also be reduced.

In some cases, the memory system 100a, 100b may reduce off-chip access occurring during the process of retrieving data stored in a peripheral device having an accelerator to the host 150a through an offloading operation. Optimizing the offloading operation may effectively reduce the power consumption and latency of the memory system 100a, 100b. Thus, the memory system 100a, 100b may improve performance related to the execution of an application and thereby increase power efficiency.

The first memory processing unit 111a, 111b may be implemented in the host processor of the host 150a, 150b or on a layer adjacent to the host processor. Although an example of implementing the first memory processing unit 111a and the first memory 113a as the first memory device 110 separate from the host 150a (e.g., the host processor) is described with reference to FIG. 1A, embodiments are not limited thereto. In the memory system 100b, the first memory processing unit 111b and the first memory 113b may be implemented to be integrated into the host 150b. An example of integrating the first memory processing unit 111b and the first memory 113b into the host 150b is described with reference to FIG. 7.

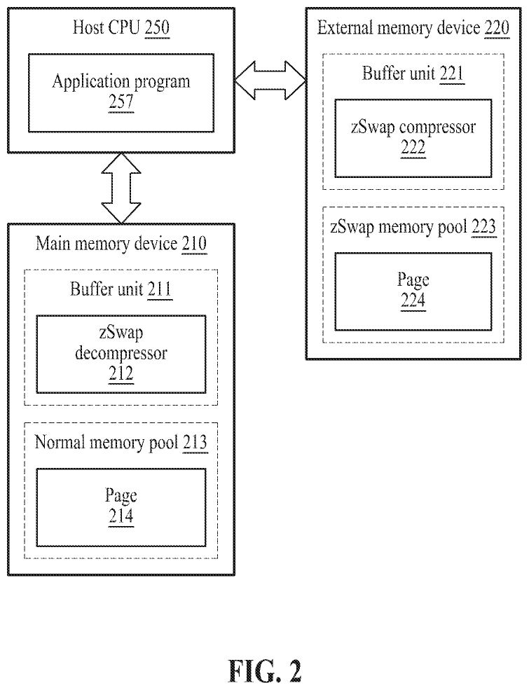

FIG. 2 illustrates swapping pages for an application in a memory system according to an embodiment.

According to an embodiment, a memory system may include a host CPU 250, a main memory device 210 (e.g., the first memory device 110 of FIG. 1A), and an external memory device 220 (e.g., the second memory device 120 of FIG. 1A and FIG. 1B). For example, when the main memory device 210 is a DIMM memory device, the external memory device 220 may be a CXL memory device or a solid-state drive (SSD) device.

The Host CPU 250 may execute an application program 257. The host CPU 250 may manage data in a memory to execute the application program 257. The host CPU 250 may manage a normal memory pool in a main memory of the main memory device 210. For example, data of the application program 257 may be stored in the main memory page-wise (e.g., by 4 kilobytes (KB)) in the case of Linux. Page-wise data may be referred to as a page. To move a portion of such pages to a swap area (e.g., the swap memory pool), the memory system may process the data through a swap frontend interface.

A zSwap operation may include an operation for page compression and decompression, an operation for managing a compressed memory area (e.g., zPool as the swap memory pool), and an operation of allocating and managing a memory space (e.g., a tree-based data structure) to store meta-information of compressed data. As described herein, with respect to the zSwap operation, a swap-in operation (e.g., decoding) may refer to a data that is offloaded to the main memory device 210, and a swap-out operation (e.g., encoding) may refer to a data that is offloaded to the external memory device 220.

When data in the main memory device 210 is not used for a particular time-period (e.g., a predetermined time), the host CPU 250 may classify the data as cold data. The host CPU 250 may move the data from the main memory device 210 to the external memory device 220 (i.e., located nearby, e.g., closest to the main memory device) to swap out the data. In a swap-out operation, a buffer unit 221 (e.g., a memory processing unit) of the external memory device 220 may perform a compression operation on the cold data and store the compressed data in the swap memory pool. A swap memory pool 223 may include a compressed page 224 and may be positioned in an external memory (e.g., external memory device 220 in FIG. 2 or second memory device 120 in FIGS. 1A-1B).

In some cases, when the host CPU 250 attempts to use the data stored in the swap memory pool 223, the main memory device 210 may receive the compressed page 224 via the host CPU 250. The page 224 may be transferred while being compressed. In a swap-in, a buffer unit 211 of the main memory device 210 may perform a decompression operation on the compressed data and provide the decompressed data to the host CPU 250 and a normal memory pool 213. The main memory device 210 may store a decompressed page 214 in the normal memory pool 213. Of the two processes, the swap-in operation refers to the task of retrieving data that is expected to be used immediately or soon by the host CPU 250, and thus, the swap-in may have a greater effect on the system performance than the swap-out operation. According to an embodiment, the memory system described with reference to the present disclosure may enable improvement of swap-in performance.

For example, the main memory device 210 may include a zSwap decompressor 212. The zSwap decompressor 212 may be implemented in the buffer unit 211 to be closer to a memory (e.g., the main memory) having the normal memory pool 213 than the external memory device 220. The zSwap decompressor 212 may include a logic circuit including decoding logic and decompressing logic. The host CPU 250 may receive the compressed page 224 to be swapped in from the swap memory pool 223 of the external memory device 220 and transfer the compressed page 224 to the main memory device 210. The buffer unit 211 may decompress the compressed page 224 through the zSwap decompressor 212. The buffer unit 211 may store the decompressed page 214 in the normal memory pool 213. The buffer unit 211 may search a compressed memory for a storage location of the data to be swapped in through a zSwap tree module. The buffer unit 211 may decompress the compressed page 224 through the zSwap decompressor 212 and store the data back in the main memory.

The external memory device 220 may include a zSwap compressor 222. The zSwap compressor 222 may be implemented in the buffer unit 221 to be closer to a memory (e.g., the external memory) having the zSwap memory pool 223 than the host CPU 250. The buffer unit 221 may receive data of the page 214 to be swapped out from the normal memory pool 213 via the host CPU 250. The buffer unit 221 may compress the page 214 through the zSwap compressor 222 and store the compressed page 224 in the zSwap memory pool 223 of the external memory. The buffer unit 221 may allocate space corresponding to the compressed size to the zSwap memory pool 223 and store the compressed page 224 in the allocated space.

As described, the memory processing unit for swapping may be disposed on a layer adjacent to a memory having memory pools (e.g., the normal memory pool 213 and the zSwap memory pool 223) in which the swapped in/out data is stored in a hierarchical memory structure. For example, the memory processing unit may also be positioned in the external memory device 220 because swapped-out cold data is stored in the external memory device (e.g., external memory device 220 nearby), thereby securing the system bandwidth. The main memory device 210 and the external memory device 220 may divide and process the functions of compression, decompression, and memory area management using large memory bandwidth during the swap processing operation.

According to an embodiment, the zSwap decompressor 212 for swap-in is positioned in the main memory device 210 in the memory system, and thus, the compressed data (e.g., the compressed page 224) may be transmitted to the main memory (e.g., main memory device 210) during the swap-in process. Thus, the memory bandwidth from the external memory device 220 to the main memory device 210 during the swap-in process may be saved (e.g., resulting in reduced bandwidth).

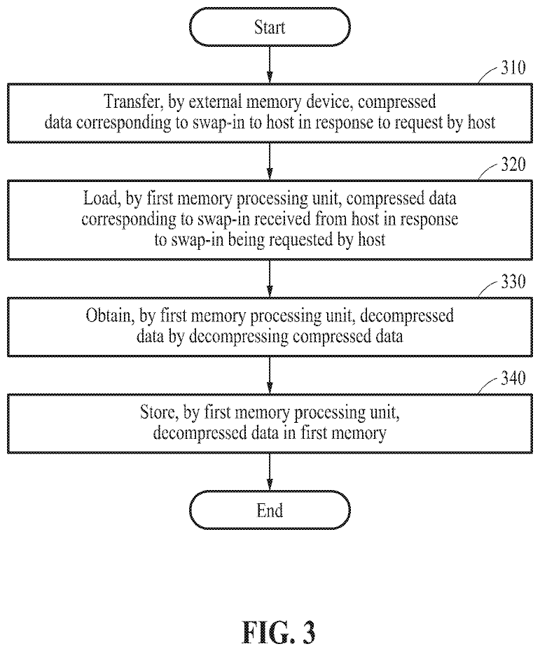

FIG. 3 is a flowchart illustrating a swap-in method performed by a memory device according to an embodiment.

According to an embodiment, a host may transfer an instruction for swap-in to a multi-layer peripheral device.

In operation 310, an external memory device (e.g., the second memory device of FIGS. 1A and 1B) may transfer compressed data corresponding to a swap-in to a host in response to a request by the host. The external memory device and the host may be positioned on different boards (as described with reference to FIGS. 1A-1B). The external memory device may autonomously manage the compressed data. The external memory device may transfer the requested data to the host without decompression.

In operation 320, a first memory processing unit may load the compressed data corresponding to the swap-in received from the host in response to the swap-in being requested by the host. The first memory processing unit and the host may be disposed on the same board. The first memory processing unit may be implemented as a main memory device separate from the host (as described with reference to FIG. 1A), but is not limited thereto, and may be implemented to be integrated into the host (as described with reference to FIG. 1B). The main memory device may store the compressed data received via the host in a main memory. The first memory processing unit may load the compressed data to the main memory.

In operation 330, the first memory processing unit may obtain decompressed data by decompressing the compressed data. The first memory processing unit may further perform decryption in addition to the decompression for the swap-in process. Details regarding the decompression process are provided with reference to FIG. 4.

In operation 340, the first memory processing unit may store the decompressed data in a first memory. The first memory processing unit may provide the decompressed data (e.g., from the first memory or main memory) directly to the host. After the swap-in process is completed, the host may access the first memory and use the decompressed data.

According to an embodiment, in a memory system, the first memory processing unit for swap-in may be positioned on a layer adjacent to a main memory layer having a normal memory pool. A second memory processing unit for swap-out may be positioned on a layer adjacent to an external memory layer having a zSwap memory pool. For example, the first memory processing unit for decoding may be positioned on a relatively high memory layer. The second memory processing unit for encoding may be positioned on a relatively low memory layer.

The high and low memory layers are used in systems that have a memory hierarchy. The layers represent different levels within the hierarchy based on the proximity of the memory to the central processing unit (CPU) and the access speeds. For example, high memory refers to memory locations at higher addresses within the system's address space and low memory refers to memory locations at lower addresses within the system's address space. Thus, a host-peripheral system may split and process a memory-related operation through a split offloading operation accelerator structure.

FIGS. 4 and 5 are diagrams illustrating a zSwap operation according to an embodiment.

FIG. 4 illustrates a swap-in operation according to an embodiment of the present disclosure.

According to an embodiment, a buffer unit 411 of a main memory device 410 may include a first memory processing unit 412. The operations of the buffer unit 411 for swap-in are described herein.

For example, in operation 401, a host 450 may receive compressed data 424 from an external memory device 420. The host 450 may obtain the compressed data 424 corresponding to target data from a second memory (e.g., the external memory device 420) in response to the target data to be used by the host 450 being cold data, and store the compressed data 424 in a first memory (e.g., a main memory). The host 450 may determine the location of the data to be used. The host 450 may determine whether the data to be used is located as cold data in a swap memory pool of the external memory device 420. When the data to be used is recognized as cold data, the host 450 may transfer the corresponding address (e.g., a DRAM address) to the external memory device. The host 450 may request the cold data (e.g., the compressed data 424) along with the DRAM address from the external memory device 420. The external memory device 420 may transmit the compressed data 424 to the host 450. For example, the compressed data 424 stored in the swap memory pool during the swap-in process may be data compressed by a predetermined ratio (e.g., 1% to 50%). However, the compression ratio of the compressed data 424 is not limited thereto, and the compressed data 424 may be compressed by a ratio of 50% or higher. In some examples, the external memory device 420 may transfer the compressed data 424 to the main memory device 410 without an operation process (e.g., without performing a decompression operation).

In operation 402, the buffer unit 411 may temporarily store the compressed data 424 received via the host 450 from the external memory device 420 in the first memory. The host 450 may transmit a swap-in request to the main memory device 410. The host 450 may write, to a register of the buffer unit 411 of the main memory device 410, the DRAM address (e.g., a destination address to be stored in the main memory) and the size (e.g., the compressed size) of the data requested to be swapped in. The host 450 may transmit the compressed data 424, as the described swap-in request, along with the destination address to the main memory device 410. The main memory device 410 may store the compressed data 424 in a main memory 413. A data manager 412-1 may store the compressed data 424 in a buffer 412-2, and a memory controller 412-3 may write the compressed data 424 stored in the buffer 412-2 to the main memory 413.

In operation 403, the first memory processing unit 412 may access the main memory 413 of the main memory device 410 and obtain (e.g., load) the compressed data 424.

In operation 404, the first memory processing unit 412 may perform decompression. The first memory processing unit 412 may be positioned in a main memory layer. The first memory processing unit 412 may decode the compressed data 424. The first memory processing unit 412 may load the compressed data 424 stored in the main memory 413 using information related to the swap-in request (e.g., the address at which the compressed data 424 is written in the main memory 413) and perform a decoding operation thereon.

According to an example, the memory controller 412-3 in the first memory processing unit 412 may transfer the compressed data 424 to a decoder 412-4. The decoder 412-4 may include a decryptor and/or a decompressor. The decoder 412-4 may decrypt data through the decryptor (e.g., based on whether the data is encrypted). The first memory processing unit 412 may decompress data using the decompressor and decrypt the decompressed data using the decryptor, depending on whether the data is encrypted and whether the data is compressed. The decryption using the decryptor may be performed before or after the decompression using the decompressor.

In operation 405, the buffer unit 411 may transfer decompressed data 414 to the host 450. A memory interface 419 of the buffer unit 411 may route the decompressed data 414 to the host 450. In addition, the buffer unit 411 may perform a decoding operation and then store the decompressed data 414 in the main memory 413. After verifying that the decoding operation is completed, the host 450 may load the decompressed data 414 from the first memory (e.g., the main memory 413) and use the decompressed data 414. The buffer unit 411 may remove the compressed data 424 from the first memory (e.g., the main memory 413) after the compressed data 424 is decompressed.

According to an embodiment, the required bandwidth between the host and peripheral devices may be reduced. By effectively improving the utilization of interface between the host and peripheral devices with a high-power consumption, the overall power efficiency of the system may be maximized.

FIG. 5 illustrates a swap-out operation according to an embodiment.

In operation 501, a host 550 may classify data unused within a certain period, among data stored in a first memory (e.g., a main memory of a main memory device 510) as cold data. The period may be set as a predetermined time, but is not limited thereto. The host 550 may request fetching of cold data from the main memory device 510. The main memory device 510 may transfer non-compressed data 514, classified as cold data, to the host 550 through an external interface (e.g., a memory interface). When the transfer to the host 550 is completed, the main memory device 510 may delete the non-compressed data 514 from the main memory. The host 550 may receive the cold data from the main memory device 510.

In operation 502, an external memory device 520 may receive the data classified as cold data from the first memory (e.g., the memory of the main memory device 510) via the host 550 and store the data in a second memory (e.g., an external memory 523). The external memory device 520 may temporarily store the non-compressed data classified as cold data in the second memory. The host 550 may request a swap-out while transferring the received cold data to the external memory device 520. The host 550 may write, to a register of a buffer unit 521 of the external memory device 520, a DRAM address (e.g., a destination address to be stored in the external memory 523) and the size (e.g., the size before compression) of data to be swapped out. The external memory device 520 may store the non-compressed data 514 (e.g., cold data) received through a memory interface 529 at an address designated in the swap-out request (e.g., the destination address in the external memory 523).

In operation 503, a second memory processing unit 522 of the buffer unit 521 may obtain compressed data 524 by compressing the non-compressed data 514. The second memory processing unit 522 may access the external memory 523 of the external memory device 520 and obtain (e.g., load) cold data. The second memory processing unit 522 may encode the cold data. For example, a memory controller 522-3 in the second memory processing unit 522 may transfer data to an encoder 522-4. The encoder 522-4 may include an encryptor and/or a compressor. The encoder 522-4 may encrypt the data using the encryptor and compress the data using the compressor. The second memory processing unit 522 may perform encryption through the encryptor and perform compression through the compressor, based on whether the data is to be encrypted and compressed, included in a previously received instruction. The encryption through the encryptor may be performed before or after the compression by the compressor.

In operation 504, the second memory processing unit 522 may store the compressed data 524 in the second memory (e.g., the external memory 523). In some cases, the data may pass from encoder 522-4 via memory interface 529 to external memory 523. The second memory processing unit 522 may store the compressed data 524 in the external memory 523 through a data manager 522-1, a buffer 522-2, and the memory controller 522-3. The buffer unit 521 may remove the non-compressed data 514 from the second memory after the compressed data 524 is stored in the second memory (e.g., the external memory 523). The compressed data 524 may be managed in a swap memory pool until used by the host 550.

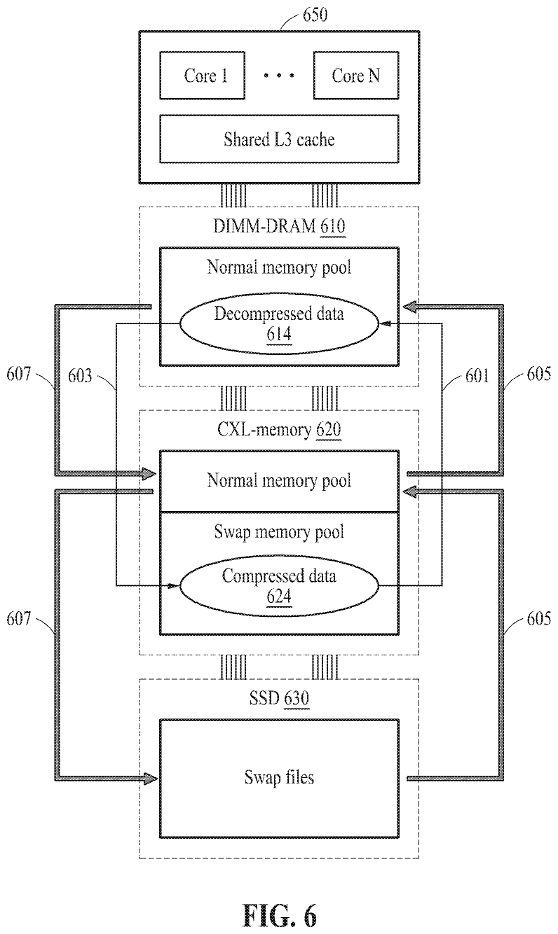

FIG. 6 illustrates a memory system with offloading using a DIMM memory and a CXL memory according to an embodiment.

According to an embodiment, a memory device (e.g., a first memory device 610) may include a memory area and a memory processing unit. In a tiered memory system including a host 650 (as shown in FIG. 6), an example in which the first memory device 610 may be a DIMM-DRAM and a second memory device 620 may be a CXL-memory is illustrated. In a hierarchical memory structure including a main memory (e.g., a DRAM) and a storage (e.g., a disk), an external memory device (e.g., a CXL memory) may act as a buffer between the DRAM and the disk because the CXL memory has a larger capacity than the DRAM and is faster than the storage. Thus, data to be swapped out (e.g., cold data) may be preferentially swapped out to the CXL memory before being moved to the disk.

The memory area of the first memory device 610 may be disposed on the same board as the host 650 and store data. The memory processing unit for a swap-in 601 may be disposed on the same board as the host 650. For example, the first memory device 610 having a first memory processing unit and a first memory may be disposed on the same board as the host 650.

For example, in the swap-in 601, the first memory device 610 may receive compressed data 624 from the second memory device 620 and perform decompression thereon. The memory processing unit of the first memory device 610 may obtain decompressed data 614 by decompressing the compressed data 624 corresponding to a swap-in request by the host 650. The memory processing unit may store the decompressed data 614 in the memory area (e.g., a normal memory pool).

As another example, in a swap-out 603, the memory processing unit of the first memory device 610 may transfer data requested to be swapped out by the host 650 to another memory device (e.g., the second memory device 620). The first memory device 610 may transfer the data requested to be swapped out to the second memory device 620 without an operation (e.g., without performing a compression operation). The second memory device 620 may generate the compressed data 624 by compressing non-compressed data, and manage the compressed data 624 in a swap memory pool. The second memory device 620 may add the compressed data 624 to the swap memory pool in case of free space in the swap memory pool.

However, if the swap memory pool in the second memory device 620 is full (i.e., the space in the swap memory pool is insufficient), the host 650 and/or the first memory device 610 may provide the non-compressed data to a storage device 630 (e.g., an SSD device). The storage device 630 may perform a non-compression swap-out 607 that stores non-compressed data as a swap file. When a non-compressed swap file is requested by the host 650, the storage device 630 may perform a non-compression swap-in 605 by providing the swap file to the first memory device 610. In the case of the non-compression swap-in 605, swap data is non-compressed, and thus, the first memory device 610 may store the swap data directly in the main memory without decompression.

For example, when the first memory device 610 is implemented as a DRAM, a buffer unit of the first memory device 610 may set a DRAM mode to process common DRAM instructions and a DEC mode to accelerate a decoding operation. The DRAM mode may be a mode that provides common DRAM access. The DEC mode may be a mode that provides DRAM access for accelerating a decoding operation. The first memory device 610 may use a partial area of a main memory address as a control address for changing the mode. The partial area may be referred to as a DRAM-MODE-CONFIG area. If DRAM-MODE-CONFIG=DEC-MODE, the buffer unit may perform an instruction processing function for accelerating a decoding operation. In addition, a DRAM-MODE-STATUS area may be defined in the first memory device 610. The host 650 may determine the current status of the main memory through this area. The host 650 may determine whether the current mode is a DRAM mode or a DEC mode or whether the DRAM status is a status of being capable of collaborating with a host that includes CMD Done, BUSY, READY, and IDLE.

For example, when the second memory device 620 is implemented as a CXL memory, a buffer unit of the second memory device 620 may set a CXL mode to process common CXL instructions and an ENC mode to accelerate an encoding operation. The CXL mode may be a mode that provides common CXL access. The ENC mode may be a mode that provides CXL access for accelerating an encoding operation. The second memory device 620 may use a partial area of an external memory address (e.g., a CXL memory address) as a control address for changing the mode. The partial area may be referred to as CXL-MODE-CONFIG. If CXL-MODE-CONFIG=ENC MODE, the buffer unit may perform an instruction processing function for accelerating an encoding operation. In addition, a CXL-MODE-STATUS area may be defined. The host 650 may determine the current status of the external memory. The host 650 may determine whether the current mode is a CXL mode or an ENC mode or whether the DRAM status is a status of being capable of collaborating with a host that includes CMD Done, BUSY, READY, and IDLE.

As described herein, the memory system may increase the performance and available memory capacity of the DIMM memory and the CXL memory using memory modules capable of accelerating encoding and/or decoding. In some cases, zSwap space may be allocated to each channel when a DIMM memory and CXL memory structure include multiple channels. Thus, in some cases, the first memory device 610 and the second memory device 620 of the memory system may process a swap-in and/or a swap-out in parallel for each channel. Since core operations are processed in the vicinity of the memory in each layer where data is stored, and then, the data is stored again, the data bandwidth efficiency may be maximized. Accordingly, off-chip communication between the host and the memory devices may be reduced.

FIG. 7 illustrates a memory system with host-based split offloading according to an embodiment.

According to an embodiment, a host may include a host processor (e.g., CPU 750) having a cache 713 corresponding to a first memory, and a first memory processing unit (e.g., a decoder 712). For example, the host processor 750 may be a processor core, and may include an ALU 751-1 and a control unit 751-2. The control unit 751-2 may retrieve instructions from a memory and instruct the host processor 750 to decode the instructions and execute the decoded instructions. The ALU 751-1 may perform arithmetic, logic, and bitwise operations when instructed by the control unit 751-2. In FIG. 7, a memory processing unit for a swap-in operation may be referred to as the decoder 712, and memory processing units for a swap-out operation may be referred to as encoders 722-1 and 722-2.

An instruction buffer 752 of the host processor 750 may receive a common memory read-write instruction, a swap-in instruction, and a swap-out instruction. When the control unit 751-2 identifies the swap-in instruction from the instruction buffer 752, the control unit 751-2 may operate a logic circuit of a decompressor 712-1 and a decryptor 712-2 with respect to cold data. In this case, the host processor 750 may store decompressed data in the cache 713. Accordingly, since a large portion of a decoding operation is offloaded to the CPU cache 713 having low latency, the system performance and efficiency may be maximized.

For example, when a compressed page is swapped in, the host processor 750 may load data (e.g., the compressed pages) stored in external memories 723-1 and 723-2 to the cache 713 (e.g., the first memory). In addition, the host processor 750 may receive an instruction including a type and an offset, and find a memory address (e.g., an address in the cache 713) at which a page to be swapped in is stored from an address table cache. In addition to the memory address, whether data is encrypted, compressed and size information (e.g., stored size information) may be stored together in the address table cache. The host processor 750 may then read the data (e.g., the compressed page) at the memory address at which the page to be swapped in is stored. The host processor 750 may decompress the page by performing decompression and/or decryption based on whether the read data is encrypted and compressed. The host processor 750 may receive the decompressed data returned, store the decompressed data in the cache 713, and use the decompressed data.

In the example shown in FIG. 7, the compressed data may be stored in various external memory devices through the swap-out operation. For example, the compressed data may be stored in the memory 723-1 of the external memory device and/or in the memory 723-2 of the additional external memory device. The external memory device may be positioned on the same board as the host and may store compressed data in the memory 723-1. A buffer unit of the memory 723-1 may include a PNM unit (e.g., the encoder 722-1)) including encoding logic. The additional external memory device and the host may be disposed on different boards, and the additional external memory device may store compressed data in the memory 723-2. The additional external memory device may include a PNM unit (e.g., the encoder 722-2) capable of performing compression corresponding a swap-in operation.

According to an embodiment, the host (e.g., the host processor or CPU 750) may determine a memory device to which data is to be swapped out according to available space in swap memory pools of memory devices different from the host. In some examples, two or more memory devices of a plurality of memory devices accessible by the host may have an encoder for a swap-out. The host may determine that a swap memory pool of the corresponding memory device is available if any of memory devices having an encoder has free space and data (e.g., a page) to be swapped can be added thereto. Additionally or alternatively, if the swap memory pool is filled and data (e.g., a page) to be swapped cannot be added thereto, the host may determine that the swap memory pool of the corresponding memory device is unavailable. The host may perform a swap-out operation preferentially to the memory device that is closest to the host among two or more memory devices (e.g., external memory device or additional external memory device) having an available swap memory pool.

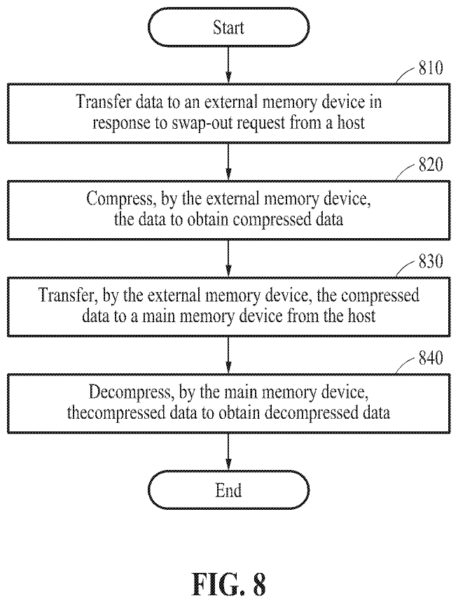

For example, the host may transfer data corresponding to a first swap-out request to the external memory device if the swap memory pool of the external memory device (e.g., the memory 723-1) is available. The external memory device may have a main memory as the memory device that is closest to the host (e.g., the main memory of the external memory device may be closer to the host than the memory of the additional external memory device). When the swap memory pool of the external memory device is unavailable, the host may transfer data corresponding to a second swap-out request to the additional external memory device. The additional external memory device may be a memory device that is connected farther from the host than the external memory device. The first swap-out request and the second swap-out request may be requests that cause a swap-out from the memory device. FIG. 8 is a flowchart illustrating a swap-out method performed by a memory device according to an embodiment.

According to an embodiment, a host may transfer an instruction for swap-out to a multi-layer main memory device.

In operation 810, a main memory device (e.g., the first memory device of FIGS. 1A and 1B) may transfer uncompressed data corresponding to a swap-out from a host in response to a request by the host. The main memory device and the host may be positioned on the same boards (as described with reference to FIGS. 1A-1B). The main memory device may transfer the requested data to the external memory device via the host. For example, the requested data may be a cold data.

In operation 820, the external memory device (e.g., second memory processing unit of the external memory device) may compress the requested data to obtain compressed data. In some cases, the second memory processing unit may load the requested data corresponding to the swap-out received from the host. The second memory processing unit and the host may be disposed on different boards. In some cases, the second memory processing unit may be implemented as an external memory device separate from the host. The external memory device may encode the cold data. For example, the external memory device may perform encryption of the cold data followed by performing a compression operation to obtain compressed data. Details regarding generation of compressed data are provided with reference to FIG. 5.

In operation 830, the external memory device may transfer the compressed data to a main memory from the host. In some cases, the second memory processing unit may transfer the compressed data to a main memory device in response to a swap-in request from the host. For example, the second memory processing unit may transfer the compressed data to the main memory device via the host. Details regarding transfer of compressed data are provided with reference to FIGS. 4-5.

In operation 840, the main memory device may decompress the compressed data to obtain decompressed data. In some cases, the first memory processing unit (i.e., first memory processing unit of the main memory device) may obtain (e.g., load) the compressed data. The first memory processing unit may decrypt and decompress the compressed data to obtain decompressed data. Details regarding decompression of compressed data are provided with reference to FIGS. 4-5.

According to an embodiment, in a memory system, the first memory processing unit for swap-in may be positioned on a layer adjacent to a main memory layer having a normal memory pool. A second memory processing unit for swap-out may be positioned on a layer adjacent to an external memory layer having a zSwap memory pool. For example, the first memory processing unit for decoding may be positioned on a relatively high memory layer. The second memory processing unit for encoding may be positioned on a relatively low memory layer.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

What is claimed is:

1. A memory system comprising:
an external memory device configured to transfer compressed data to a host in response to a swap-in request from the host; and
a first memory processing unit of a main memory device configured to load the compressed data, decompress the compressed data to obtain decompressed data, and store the decompressed data in a main memory of the main memory device.

2. The memory system of claim 1, wherein a buffer unit comprising the first memory processing unit is configured to:
store the compressed data received from the external memory device in the main memory,
perform a decompression operation on the compressed data to obtain the decompressed data,
transfer the decompressed data to the host, and
remove the compressed data from the main memory after the compressed data is decompressed.

3. The memory system of claim 1, wherein the external memory device comprises:
a second memory processing unit configured to receive data from the main memory in response to a swap-out request, and compress the received data to obtain compressed data; and
a second memory configured to store the compressed data.

4. The memory system of claim 1, wherein the external memory device is further configured to:
store non-compressed data classified as cold data in a second memory,
compress the non-compressed data to obtain the compressed data,
store the compressed data in the second memory, and
remove the non-compressed data from the second memory after the compressed data is stored in the second memory.

5. The memory system of claim 1, wherein:
the host is configured to classify data unused within a period as cold data, and
the external memory device is further configured to receive the data classified as cold data from the main memory and store the received data in a second memory.

6. The memory system of claim 1, wherein the host is configured to load the decompressed data from the main memory and use the compressed data.

7. The memory system of claim 1, wherein the first memory processing unit is implemented in a host processor or on a layer adjacent to the host processor.

8. The memory system of claim 1, wherein
a main memory device having the first memory processing unit and the main memory is disposed on the same board as the host, and
the external memory device is disposed on a different board than the host.

9. The memory system of claim 1, wherein the host comprises a host processor having a cache corresponding to the main memory and the first memory processing unit.

10. The memory system of claim 9, further comprising:
an additional external memory device configured to perform a compression, the additional external memory device and the host being disposed on different boards,
wherein the host is configured to:
transfer data to the external memory device when a swap memory pool of the external memory device is available, and
transfer data to the additional external memory device when the swap memory pool of the external memory device is unavailable.

11. A method of operating a memory system, the method comprising:
transferring, by an external memory device, compressed data to a host in response to a swap-in request from the host;
loading, by a first memory processing unit, the compressed data in response to the swap-in request;
decompressing, by the first memory processing unit, the compressed data to obtain decompressed data; and
storing, by the first memory processing unit, the decompressed data in a first memory.

12. The method of claim 11, wherein the loading of the compressed data comprises storing the compressed data received from the external memory device in the main memory,
wherein the method further comprises:
performing a decompression operation on the compressed data to obtain the decompressed data;
transferring the decompressed data to the host; and
removing the compressed data from the main memory after the compressed data is decompressed.

13. The method of claim 11, further comprising:
receiving, by a second memory processing unit of the external memory device, data from the first memory via the host in response to a swap-out request from the host; and
compressing, by the second memory processing unit, the received data to obtain the compressed data.

14. The method of claim 11, further comprising:
storing non-compressed data identified as cold data in a second memory;
compressing the non-compressed data to obtain the compressed data;
storing the compressed data in the second memory; and
removing the non-compressed data from the second memory after the compressed data is stored in the second memory.

15. The method of claim 11, further comprising:
classifying, by the host, data unused within a period as cold data; and
receiving, by the external memory device, the data classified as cold data from the main memory and store the received data in a second memory.

16. The method of claim 11, further comprising:
loading, by the host, the decompressed data from the main memory and using the compressed data.

17. The method of claim 11, wherein the first memory processing unit is implemented in a host processor of the host or on a layer adjacent to the host processor.

18. The method of claim 11, wherein the host comprises a host processor having a cache corresponding to the main memory and the first memory processing unit,
wherein the method further comprises:
transferring, by the host, data to the external memory device when a swap memory pool of the external memory device is available; and
transferring, by the host, data to an additional external memory device when the swap memory pool of the external memory device is unavailable,
wherein the external memory device and the host are disposed on different boards, and
wherein the additional external memory device is configured to perform a compression, the additional external memory device and the host being disposed on different boards.

19. A non-transitory computer-readable storage medium storing instructions that, when executed by a processor, cause the processor to perform the method of claim 11.

20. A memory device comprising:
a memory area disposed on a same board as a host, wherein the memory area is configured to store data; and
a memory processing unit disposed on the same board as the host, wherein the memory processing unit is configured to decompress the compressed data to obtain decompressed data, store the decompressed data in the memory area, and transfer data to another memory device.
